(19) United States
(12) Patent Application Publication
(10) Pub. No.: US 2014/0003854 A1
(43) Pub. Date: Jan. 2, 2014

(54) PRINTER WITH PAPER TRAY ASSEMBLY

(71) Applicant: HON HAI PRECISION INDUSTRY CO., LTD., New Taipei (TW)

(72) Inventor: YI-LONG LEE, New Taipei (TW)

(73) Assignee: HON HAI PRECISION INDUSTRY CO., LTD., New Taipei (TW)

(21) Appl. No.: 13/868,340

(22) Filed: Apr. 23, 2013

(30) Foreign Application Priority Data
Jun. 29, 2012 (TW) 101123430

(51) Int. Cl. B41J 13/10

(52) U.S. Cl. CPC B41J 13/10
USPC 400/624

(57) ABSTRACT

A printer includes a printer body and a paper tray assembly mounted to the printer body. The paper tray assembly includes a first paper tray and a second paper tray mounted to the first paper tray. The first paper tray includes a first bottom panel and two side portions extending from the first bottom panel. The second paper tray includes a mounting tray, an extending panel movably mounted to the mounting tray, and an elastic element resiliently contacting between the extending panel and the mounting tray. The mounting tray moves on the two side portions along a first direction substantially parallel to the first bottom panel to drive the extending panel to move to an unfolded position. The elastic element rebounds to drive the extending panel to move along a second direction to enable the extending panel to be in the same plane with the first bottom panel.

### BACKGROUND

1. Technical Field

The present disclosure relates to printers, particularly to a printer with a paper tray assembly.

2. Description of Related Art

A printer includes two paper trays for loading paper. The paper trays are divided into a plurality of parts to be folded for conserving space. However, the parts of the paper tray are not located to a plane when they are unfolded, which may crinkle the paper.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of a printer with a paper tray assembly in accordance with one embodiment of the present disclosure.

FIG. 2 is an isometric view of an extending panel of FIG. 1.

FIG. 3 is an assembled view of FIG. 1.

FIG. 4 is a cutaway view of FIG. 3 taken along line IV-IV.

FIG. 5 is another assembled view of FIG. 1, the paper tray assembly in unfolded position.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

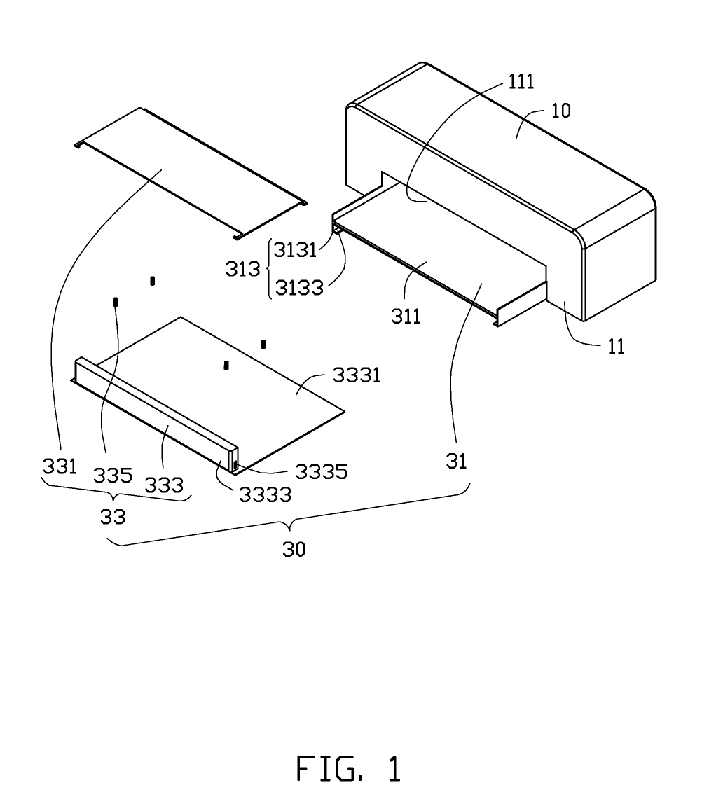

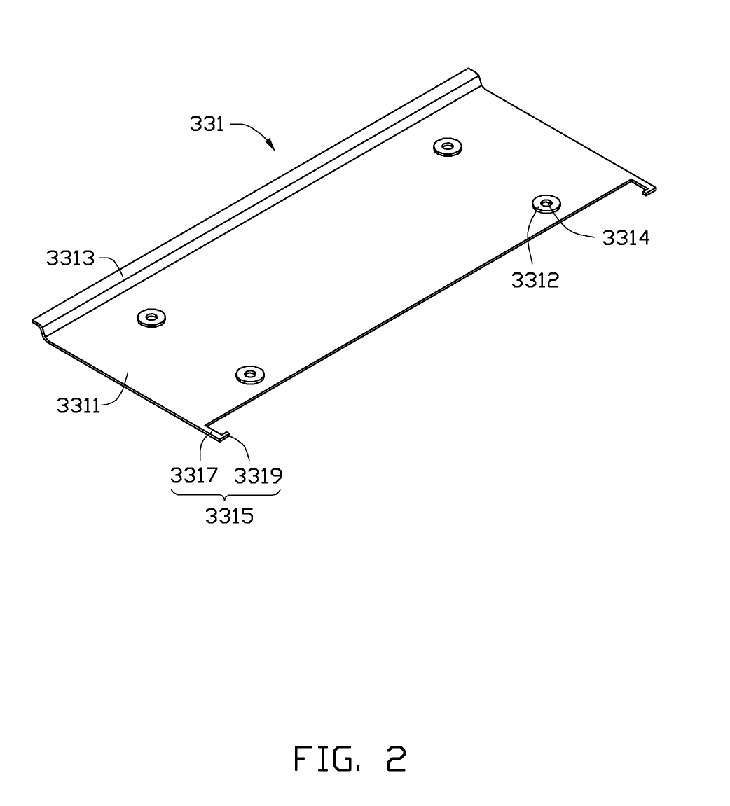

FIGS. 1 and 2 show a printer in accordance with one embodiment. The printer includes a printer body 10 and a paper assembly 30 mounted to the printer body 10.

The printer body 10 includes a plane panel 11. The plane panel 11 defines a receiving opening 111 for receiving the paper tray assembly 30.

The paper tray assembly 30 includes a first paper tray 31 and a second paper tray 33 mounted under the first paper tray 31.

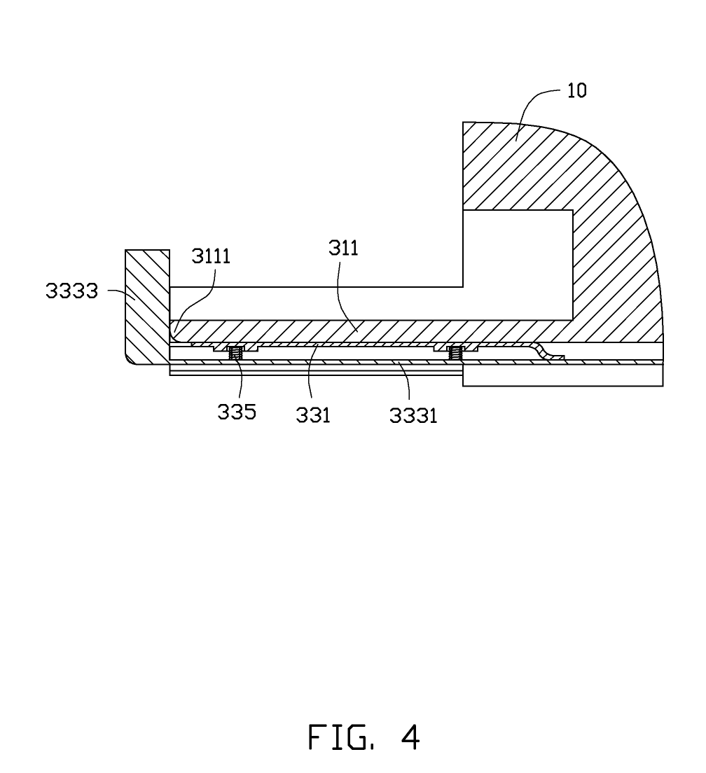

The first paper tray 31 is connected to the printer body 10 and is received in the receiving opening. The first paper tray 31 includes a first bottom panel 311 and two side portions 313, extending from opposite sides of the first bottom panel 311. Each side portion 313 is L-shaped. Each side portion 313 includes a side flange 3131 and a support flange 3133, extending from the side flange 3131. The support flange 3133 is substantially perpendicular to the side flange 3131 and is substantially parallel to the first bottom panel 311. The first bottom panel 311 includes a curved portion 3111 (shown in FIG. 4).

The second paper tray 33 includes an extending panel 331, a mounting tray 333 and four elastic elements 335. The extending panel 331 includes an extending panel body 3311, substantially parallel to the first bottom panel 311, a connecting portion 3313, extending from the extending panel body 3311, and two mounting portions 3315, extending from the extending panel body 3311. The connecting portion 3313 is curved to be mated with the curved portion 3111. The mounting portion 3315 is elastic. Each mounting portion 3315 is L-shaped. Each mounting portion 3315 includes a connecting arm 3317 connected to the extending panel body 3311 and a mounting protrusion 3319 extending from the connecting arm 3317. The extending panel 331 further includes four positioning portions 3312, extending from the extending panel body 3311. Each positioning portion 3312 defines a positioning hole 3314 for receiving one of the elastic elements 335. In one embodiment, the elastic element 335 is a spring.

The mounting tray 333 includes a second bottom panel 3331 substantially parallel to the first bottom panel 311 and a side panel 3333 substantially perpendicularly extending from the second bottom panel 3331. The side panel 3333 defines two elongated holes 3335 corresponding to the two mounting protrusions 3319. The extending direction of the elongated hole 3335 is substantially perpendicular to the first bottom panel 311. The side panel 3333 is substantially perpendicular to the side flange 3131.

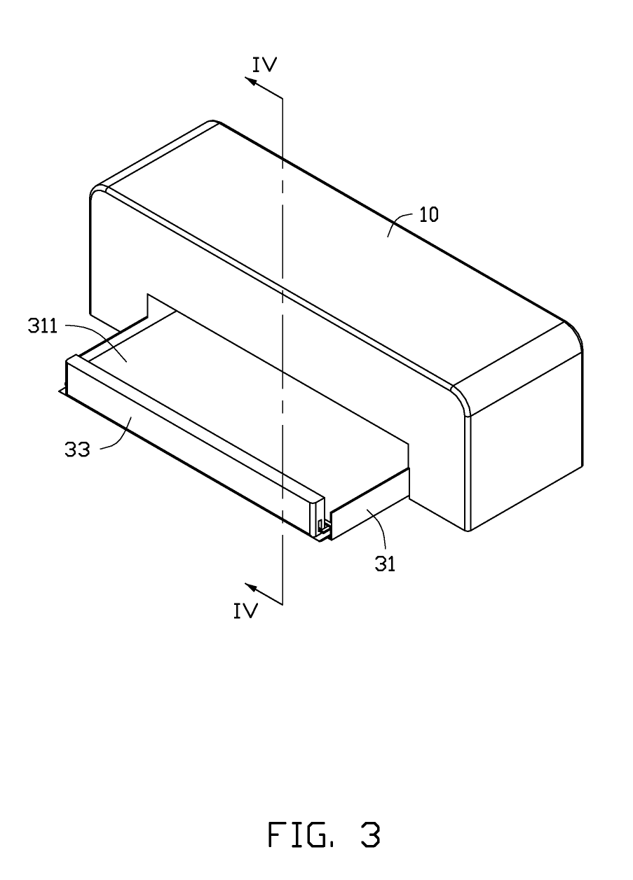

FIGS. 3 and 4 show assembly, whereby four elastic elements 335 are received in the positioning holes 3314 of the extending panel 331. The two connecting arms 3317, of the extending panel 331, are splayed to enable the two mounting protrusions 3319, to be received in the two elongated holes 3335. At this time, the elastic elements 335 resiliently contact between the second bottom panel 3331 of the mounting tray 333 and the extending panel body 3311 of the extending panel 331.

The second bottom panel 3331 of the assembled second paper tray 33 corresponds to the support flanges 3133. The connecting portion 3313 contacts the curved portion 3111. The second paper tray 33 is pushed along a first direction substantially parallel to the first bottom panel 311 of the first paper tray 31. The mounting tray 333 moves along the first direction. The extending panel 331 is resisted by the first bottom panel 311 to move downward at the beginning of the movement. At this time, the mounting protrusions 3319 move downward in the elongated holes 3335, the elastic elements 335 are compressed. The second paper tray 33 is continually pushed to be received under first bottom panel 311. At this time, the second paper tray 33 is in a folded position.

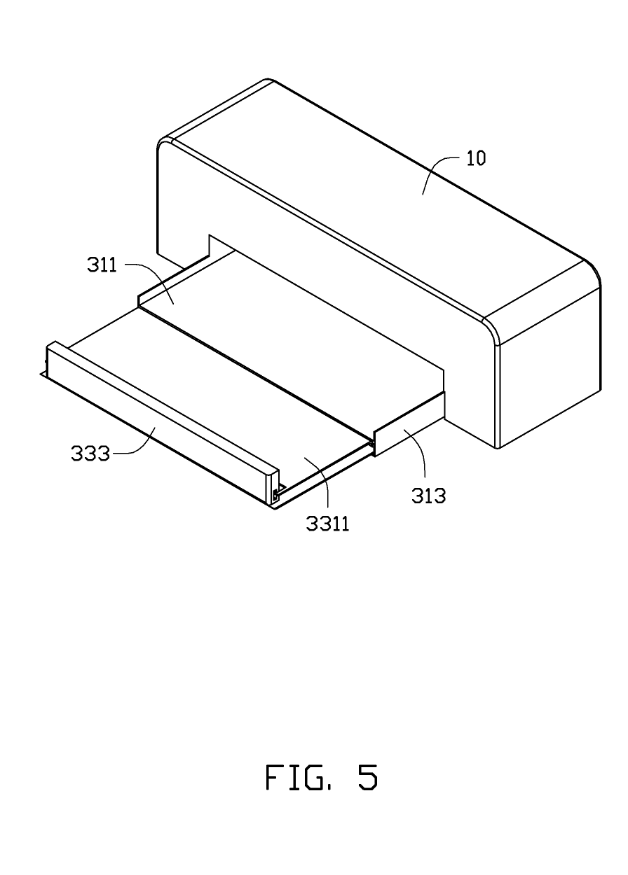

Referring to FIG. 5, in use, the second paper tray 33 is pulled along a second direction opposite to the first direction until the connecting portion 3313 contacts the curved portion 3111 of the first paper tray 31. At this time, the second paper tray 33 is in an unfolded position, the elastic elements 335 rebound to drive the extending panel body 3311 to move along a third direction substantially perpendicular to the first bottom panel 311, thereby enabling the extending panel body 3311 to be located in the same plane with the first bottom panel 311. In this way, the paper placed on the paper tray assembly 30 cannot be crinkled.

It is to be understood, however, that even though numerous characteristics and advantages of the embodiments have been set forth in the foregoing description, together with details of the structure and functions of the embodiments, the disclosure is illustrative only, and changes may be made in detail, especially in the matters of shape, size, and arrangement of parts within the principles of the present disclosure to the full extent indicated by the broad general meaning of the terms in which the appended claims are expressed.

What is claimed is:

1. A printer, comprising:
a printer body; and
a paper tray assembly mounted to the printer body, the paper tray assembly comprises a first paper tray and a second paper tray mounted to the first paper tray; the first paper tray comprises a first bottom panel and two side portions, extending from the first bottom panel; the second paper tray comprises a mounting tray, an extending panel movably mounted to the mounting tray, and an elastic element resiliently contacting between the extending panel and the mounting tray; the mounting tray is configured to move on the two side portions along a first direction, that is substantially parallel to the first bottom panel, to drive the extending panel to move to an unfolded position; and the elastic element is configured to rebound to drive the extending panel to move along a second direction, that is substantially perpendicular to the first bottom panel, to enable the extending panel to be in the same plane with the first bottom panel when the extending panel is in the unfolded position.

2. The printer of claim 1, wherein the first bottom panel comprises a curved portion; the extending panel comprises an extending panel body substantially parallel to the first bottom panel and a connecting portion extending from the extending panel body; the connecting portion is mated with the curved portion; and the connecting portion is configured to contact the curved portion when the extending panel is in the unfolded position.

3. The printer of claim 1, wherein the extending panel comprises an extending panel body substantially parallel to the bottom panel and two mounting portions, extending from the extending panel body; the mounting tray defines two elongated holes; and the two mounting portions are received in the two elongated holes and are movable in the elongate holes.

4. The printer of claim 3, wherein each of the two mounting portions are L-shaped; each of the two mounting portions comprises a connecting arm extending from the extending panel body and a mounting protrusion extending from the connecting arm; and the two mounting protrusions are received in the two elongated holes.

5. The printer of claim 3, wherein extending direction of each of the two elongated holes is substantially perpendicular to the first bottom panel.

6. The printer of claim 3, wherein the mounting tray comprises a second bottom panel, substantially parallel to the first bottom panel, and a side panel, extending from the second bottom panel; the side panel is substantially parallel to the second bottom panel; and the two elongated holes are defined in the side panel.

7. The printer of claim 6, wherein the side panel is substantially perpendicular to the first direction.

8. The printer of claim 1, wherein each of the two side portions comprises a side flange, extending from the first bottom panel, and a support flange, extending from the side flange; the side flange is substantially perpendicular to the support flange; the support flange is substantially parallel to the first bottom panel; and the mounting tray is placed on the two support flanges of the two side portions.

9. The printer of claim 8, wherein the side flange is substantially parallel to the first direction.

10. The printer of claim 1, wherein the extending panel comprises an extending panel body substantially parallel to the first bottom panel and a positioning portion extending from the extending panel body, and the positioning portion defines a positioning hole receiving the elastic element.

11. A printer, comprising:
a printer body, the printer body; and
a paper tray assembly mounted to the printer body, the paper tray assembly comprises a first paper tray and a second paper tray; the first paper tray secured to the printer body; the first paper tray comprises a first bottom panel and two side portions extending downward from the first bottom panel; the second paper tray is placed on the two side portions and located under the first bottom panel; the second paper tray is configured to move to an unfolded position relative to the side portions to enable a part of the second paper tray to be in the same plane with the first bottom panel.

12. The printer of claim 11, wherein the second paper tray comprises a mounting tray, an extending panel movably mounted to the mounting tray, and an elastic element resiliently contacting between the extending panel and the mounting tray; the mounting tray is configured to move on the two side portions along a first direction, that is substantially parallel to the first bottom panel, to drive the extending panel to move to the unfolded position; and the elastic element is configured to rebound to drive the extending panel to move along a second direction, that is substantially perpendicular to the first bottom panel, to enable the extending panel to be in the same plane with the first bottom panel when the extending panel is in the unfolded position.

13. The printer of claim 12, wherein the first bottom panel comprises a curved portion; the extending panel comprises an extending panel body substantially parallel to the first bottom panel and a connecting portion extending from the extending panel body; the connecting portion is mated with the curved portion; and the connecting portion is configured to contact the curved portion when the extending panel is in the unfolded position.

14. The printer of claim 12, wherein the extending panel comprises an extending panel body substantially parallel to the bottom panel and two mounting portions extending from the extending panel body; the mounting tray defines two elongated holes; and the two mounting portions are received in the two elongated holes and are movable in the elongate holes.

15. The printer of claim 14, wherein each of the two mounting portions are L-shaped; each of the two mounting portions comprises a connecting arm extending from the extending panel body and a mounting protrusion extending from the connecting arm; and the two mounting protrusions are received in the two elongated holes.

16. The printer of claim 14, wherein extending direction of each of the two elongated holes is substantially perpendicular to the first bottom panel.

17. The printer of claim 14, wherein the mounting tray comprises a second bottom panel, substantially parallel to the first bottom panel, and a side panel, extending from the second bottom panel; the side panel is substantially parallel to the second bottom panel; and the two elongated holes are defined in the side panel.

18. The printer of claim 12, wherein each of the two side portions comprises a side flange, extending from the first bottom panel, and a support flange, extending from the side flange; the side flange is substantially perpendicular to the support flange; the support flange is substantially parallel to the first bottom panel; and the mounting tray is placed on the two support flanges of the two side portions.

19. The printer of claim 18, wherein the side flange is substantially parallel to the first direction.

20. The printer of claim 12, wherein the extending panel comprises an extending panel body substantially parallel to the first bottom panel and a positioning portion extending from the extending panel body, and the positioning portion defines a positioning hole receiving the elastic element.
